(19) United States
(12) Patent Application Publication
(10) Pub. No.: US 2012/0011243 A1
(43) Pub. Date: Jan. 12, 2012

(54) UNIFORM RESOURCE LOCATOR (URL) CHECK

(76) Inventors: Ching-Chung Chuang, Taipei (TW); Wei-Ping Lin, Taipei (TW); Yu-Fu Kuo, Taipei (TW)

(21) Appl. No.: 12/833,268

(22) Filed: Jul. 9, 2010

(51) Int. Cl. G06F 15/173; G06Q 30/00

(52) U.S. Cl. 709/224; 705/14.53

(57) ABSTRACT

Check code and a uniform resource locators (URL) are sent from a server to a computer. The check code, when executed on the computer, lists a reference to the URL so that an attribute of the listed reference to the URL varies depending on whether the URL is in a list indicating URLs visited by the computer, and forwards to the server, based on the attribute of the listed reference to the URL, an indication as to whether the URL is in the list indicating URLs visited by the computer. Content to be sent to the computer is selected based on the indication.

### BACKGROUND

Internet advertising places an emphasis on targeted marketing. Marketing messages are targeted based on specific behaviors, tastes and interests of consumers. For example, a maker of life preservers might advertise on a web page discussing canoe trips because a user reading about canoes might be a likely purchaser of a life preserver. A user doing a search on life preservers might also be a likely purchaser of a life preserver, so an advertisement on a web page showing search results for “life preserver” might be a very effective targeted advertisement.

The more information known about a user, the more specific the user can be targeted with advertisements that might be of interest to the user. It is therefore desirable to discover user interests in order to place before the user advertisements that would most likely be of interest to the user.

### SUMMARY

In accordance with embodiments of the present invention, check code and a uniform resource locator (URL) are sent from a server to a computer. The check code, when executed on the computer, lists a reference to the URL so that an attribute of the listed reference to the URL varies depending on whether the URL is in a list indicating URLs visited by the computer, and forwards to the server, based on the attribute of the listed reference to the URL, an indication as to whether the URL is in the list indicating URLs visited by the computer. Content to be sent to the computer is selected based on the indication.

### BRIEF DESCRIPTION OF THE DRAWINGS

FIG. 1 is a simplified block diagram illustrating how information about websites visited by a user is obtained in accordance with an embodiment of the invention.

FIG. 2 is a simplified flowchart illustrating how information about websites visited by a user is used to provide content to the user in accordance with an embodiment of the invention.

### DESCRIPTION OF THE EMBODIMENT

The more information that is known about a user, the more accurately content and advertisements can be placed on web pages that target the user. Tracking information about a user can be accumulated that provides information about the user. This tracking information can, for example, be stored on the user's computer as a cookie.

For example, tracking information can be accumulated based on web sites that have been visited by the computer. The tracking information can be used to help select personalized content, such as targeted advertisements, targeted news stories and targeted offers of service that might be of interest to the user.

For example, suppose a user's visits a baby care report page. An advertiser advertising on the baby care report page can generate tracking information indicating that the user's computer visited the baby care report page. The tracking information can be stored by the server or can be stored as part of a cookie on the user's computer. To limit the amount of tracking information stored on a user's computer, the tracking information may not include every web site visited by the user's computer, but merely note, for example, that the user's computer has visited a threshold number of web sites pertaining to babies. The user can thus be categorized as a person likely to be interested in products having to do with babies.

The next day, the user may visit a political news page. If the advertiser also advertises on the political news page, the advertiser can access the tracking information on the user's computer and from the tracking information determine whether the user on the computer is likely to be interested in products about babies. If so, the advertiser then could place an advertisement related to baby care on the political news page. The tracking information on the user's computer has informed the advertiser that the user, currently visiting a political web page that is not related to baby care, has exhibited web behavior that is consistent with an interest in baby care products. This suggests to the advertiser to place a targeted advertisement on the political web page currently viewed by the user. Thus targeted advertisements can be extended to allow targeted advertising to users as they browse web pages with a variety of content perhaps unrelated to the advertised products.

One limitation on the above-described example of targeted advertising is the necessity to be able to detect when a user visits a web page. For example, an advertiser can detect a web page has been visited by placing tracking code in the web page that will be executed when a user requests to view the content of the website. The tracking code captures tracking information and stores the tracking information in the server. Based on the captured tracking information, the advertiser can provide advertisements to the user that are related to the content of the visited web page. However, an advertiser may not be able to place tracking code in a targeted web page. In embodiments of the present invention, this limitation is overcome by using a routine that checks uniform resource locators (URLs) visited by a user's computer.

A list of URLs for web pages recently visited by a user is normally stored in the user's computer. This list of URLs assists redirection back to web pages previously visited. The list of URLs also makes it possible to indicate to a user which web sites have been recently visited by displaying any reference to a visited website with a different attribute than the attribute used to highlight references to websites that have not recently been visited. For example, the attribute may be display color so that the color with which a reference to a URL is displayed is dependent on whether the URL has recently been visited by the user's computer. The attribute can also be, for example, font type, font size, blinking type, or some other attribute associated with displaying the reference.

To protect the user's privacy, access to the list of URLs stored in a computer is usually restricted. However, using various embodiments of the present invention, it can be determined if particular websites have been visited by a user's computer by checking the pertinent attribute of references to URLs that are displayed. This provides information about web pages visited by a user's computer even for web pages on which the advertiser does not have a presence. This indirect checking of which web pages have been visited by a user's computer can provide a wealth of useful information to an advertiser preparing advertisements targeted to a user or to any content provider desiring to provide content targeted to the user's presumed interests.

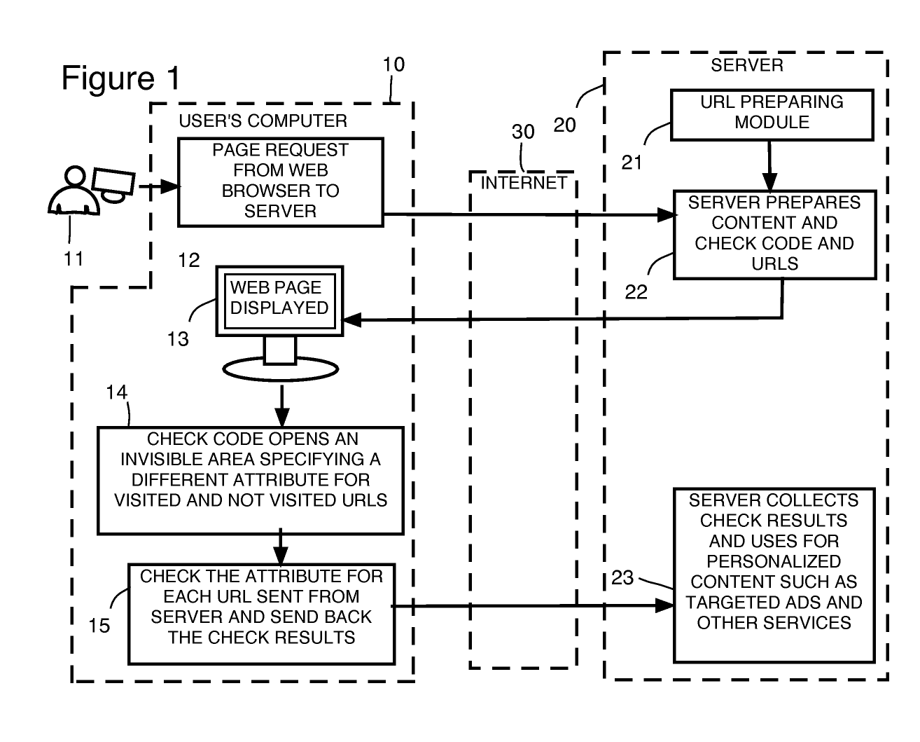

FIG. 1 is a simplified block diagram illustrating how information about websites visited by a user 11 of a computer 10 is obtained in accordance with an embodiment of the invention.

In a block 12, a page request is made from a web browser on computer 10 through the internet 30 to a server 20. In a block 21, server 20 prepares web page content and check code and URLs to be sent back to computer 10. A URL preparing module 21 selects URLs to be displayed by the check code on computer 10. Selection of URLs is discussed further below.

In a block 13, the computer receives the web page content, the check code and the URLs from server 20 and displays the web page content. In a block 14, the check code, running on computer 10, opens a display area not displayed to user 11. In the display area not displayed to user 11, check code lists references to the URLs selected by URL preparing module 21 and sent by server 20 to computer 10. For example, the URLs are listed in a hidden iframe. Cascading Style Sheets (CCS) are used to list references to URLs that have been visited using an attribute that is different dependent upon whether the URLs have recently been visited by computer 10. For example, the attribute may be the color in which the reference to the URL is displayed. Alternatively, the attribute may to display the reference to the URL as blinking when the URL has recently been visited by computer 10. Another attribute such as font type or font size can be used so long as the attribute is different depending upon whether the URL has recently been visited by computer 10.

In a block 15, the check code checks the attribute used to list each of the references to URLs selected by URL preparing module 21 and sent by server 20 to computer 10 to determine which of theses URLs have recently been visited by computer 10. For example, check code discovers which URLs have recently been visited by using the Javascript function currentStyle to check the attribute used to display the reference to the URL. Description of how to check the attributes of displayed URLs and even snippets of code to perform this is available on the internet. See for example, http://linuxbox.co.uk/stealing-browser-history-with-javascipt-and-css.php and http://www.merchantos.com/makebeta/tools/spyjax.

The results of the check that indicates which of theses URLs have recently been visited by computer 10 are sent back to server 20.

In a block 23, server 20 collects results received from computer 10. The results of the check are stored and used as tracking information. The tracking information allows an advertiser to present the user with targeted advertisements and to provide other content and services selected on the basis of web sites visited by computer 10.

URL preparing module 21 selects URLs to be sent to computer 10 based on what tracking information obtained from computer 10 would be useful to an advertiser or content provider. For example, suppose a content provider wanted to select an advertisement to display to user 11 that would be likely to interest user 11. Tracking information accumulated about web sites recently visited by computer 10 would be useful in the selection process. Therefore, when accumulating tracking information, URLs can be selected to computer 10 that would provide the content provider with pertinent information about available content. The URLs can be suggested or specified by an advertiser or a domain expert and can be generated based on content from search engines, and web page content.

Embodiments of the present invention allow keyword retargeting to be performed even without owning the search engine on which a search is performed. For example, suppose one available advertiser was a travel agency specializing in travel to Asia. It would be very useful for a content provider to know whether user 11 recently submitted a search on a search engine that used a key word or a key phrase related to travel in Asia. Using the server prepared check code and URLs it is possible to check computer 10 to see if this is the case.

For example, the key phrase “Asia Hotel” could have been previously submitted to a search engines such as the Google search engine, the Yahoo search engine, the Bing search engine and the Baidu search engine to obtain the URLs for the search results pages returned by each search engine for this key phrase. The obtained URLs can be stored, for example, by URL preparing module 21. When server 20 sends check code and URLs to computer 10, the obtained URLs can be provided with corresponding check code to computer 10. The check code will reveal whether computer 10 has recently visited the URL, and thus whether computer 10 has recently performed a search on the phrase “Asia Hotel” on any of the above-listed search engines. This facilitates presenting to user 11 retargeted advertisements based on the search for “Asia Hotel”. Such retargeted search word advertisements can be presented to user 11 from any web page on which advertisements can be disclosed to user 11, even when the main subject matter of the web page currently being viewed by user 11 is unrelated to travel in Asia.

An indirect way to determine whether user 11 has recently performed a search on a key word or key phrase is to check whether the user has visited any of the websites that are typically returned when a search on the key word or key phrase is performed. This indirect way of determining whether user 11 has recently performed a search can be useful even when the search engine does not return the same search page URL every time a key word or key phrase is searched.

For example, the key phrase “Asia Hotel” could be submitted to a search engines such as the Google search engine, the Yahoo search engine, the Bing search engine and the Baidu to obtain the URLs for the top three or four websites listed in the first page of search results from each search engine. The obtained URLs can be stored by URL preparing module 21. When server 20 sends check code and URLs to computer 10, the obtained URLs can be provided with corresponding check code to computer 10. If computer 10 lists references to any of these URLs using the attribute indicating computer 10 has recently visited the URL, then tracking information can be generated indicating computer 10 has recently visited a top listed website returned by a search on the phrase “Asia Hotel”. This suggests user 11 recent performed a search on the phrase “Asia Hotel” or a similar phrase. This obtained tracking information facilitates presenting to user 11 advertisements related to hotels in Asia and travel in Asia. Such advertisements can be presented to user 11 from any web page on which ads can be disclosed to user 11, even when the main subject matter of the web page currently being viewed by user 11 is unrelated to travel in Asia.

Website retargeting advertisements can also be accomplished using various embodiments of the present invention. This can be done for individual websites or for categories of websites. For example, a user can be categorized based on visited websites. To do so, URL preparing module 21 can select URLs to provide to computer 10 based on an intention to place user 11 in particular categories. For example, URLs for web pages of luxury automobiles and golf can be sent to computer 10. If these sites are visited, this may suggest, for example, that user 11 has a certain amount of discretionary income. Placing user 11 in a category labeled “discretionary income” suggests to advertisers that user 11 may be open to make purchases that others with discretionary income typically make, such as golfing vacations, golf equipment, luxury vehicles, or even expensive gifts such as jewelry. Appropriate advertisements based on such tracking information can help an advertiser select advertisements to be displayed to user 11 as user 11 visits different kinds of web pages.

In addition to targeted advertising, tracking information can be used to select other types of personalized content to be displayed to user 11. For example, a website may present excerpts of news stories or magazine articles to user 11 when user 11 visits the website. Selection of the excerpts displayed can be based on a number of different criteria such as popularity with others, value of content as determined by the content provider, previously indicated user preferences or even categories in which the user is placed by tracking information stored on the user's computer. Such tracking information provided by server 20 thus allows content providers to select personalized content to be displayed that may prove of special interest to user 11.

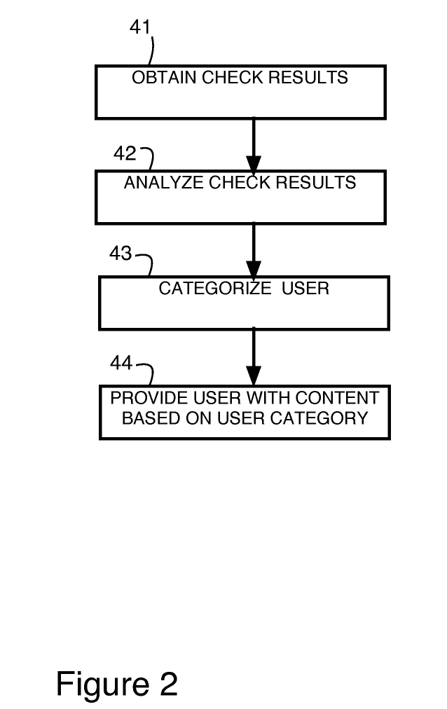

FIG. 2 is a simplified flowchart illustrating how the tracking information gathered by server 20 is used to provide personalized content to user 11. In a block 41, check results are obtained from a user. In a block 42, the check results are analyzed. Based on the analysis, in a block 43, the user is categorized. In a block 44 content is provided to the user based on the category or categories the user has been placed in.

For example, during the analysis in block 42, it may be noted that the check results from the user indicate that computer 10 has visited four web sites that pertain to women's make-up. If it is assumed that visitors to any women's make-up web page are likely to be 60% female and 40% male, statistical analysis performed in block 42 can be used in block 43 to categorize user 11 of computer 10 as more than 95% likely to be female and less than 5% likely to be male. For example, if computer 10 has visited only three web sites that pertain to women's make-up, user 11 of computer 10, based on the same statistical analysis, may be categorized as 93.6% likely to be female and 6.4% likely to be male. For example, if computer 10 has visited only two webs site that pertains to women's make-up, user 11 of computer 10 may be categorized as 84% likely to be female and 16% likely to be male.

The categorization of user 11 based on web sites visited by computer 10 can be stored as part of the tracking information stored in computer 10 as a cookie. This categorization can be used to provide personalized content, such as news stories or advertisement, to user 11 of computer 10 as other websites are visited and the tracking information is obtained and considered when selecting content to display.

Various embodiments of the present invention make keyword retargeting advertisements possible without directly receiving search engine requests or results, make website retargeting advertisements possible without placing tracking code on targeted websites, and make personalized content delivery possible without explicitly requesting information from users.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

We claim:

1. A computer implemented method comprising:
sending check code and a plurality of uniform resource locators (URLs) from a server to a computer;
executing the check code on the computer, including for each URL from the plurality of URLs:
listing a reference to the URL so that an attribute of the listed reference to the URL varies depending on whether the URL is in a list indicating URLs visited by the computer, and
forwarding to the server, based on the attribute of the listed reference to the URL, an indication as to whether the URL is in the list indicating URLs visited by the computer; and,
selecting personalized content to be sent to the computer based on the URLs visited by the computer.

2. A computer implemented method as in claim 1 wherein selecting personalized content to be sent to the computer based on the URLs visited by the computer comprises:
using the URLs visited by the computer to place the user of the computer in a category; and
selecting advertising content based on the category.

3. A computer implemented method as in claim 1 wherein selecting personalized content to be sent to the computer based on the URLs visited by the computer comprises:
using the URLs visited by the computer to place the user of the computer in a category;
storing on the computer tracking information indicating the category the user has been placed in; and,
selecting personalized content based on the category.

4. A computer implemented method as in claim 1 wherein the references to the plurality of URLs are listed by the computer in a display area that is not visible to a user of the computer.

5. A computer implemented method as in claim 1 wherein the plurality of URLs are selected by an advertiser or domain expert.

6. A computer implemented method as in claim 1 wherein the plurality of URLs are selected based on search results for a key word or key phrase.

7. A computer implemented method as in claim 1 wherein the plurality of URLs are selected based on search results returned by a search engine for a key word or key phrase.

8. A computer implemented method as in claim 1 wherein selecting personalized content to be sent to the computer based on the URLs visited by the computer comprises:
using the URLs visited by the computer to place the user of the computer in a category;
storing on the computer as part of a cookie tracking information indicating the category the user has been placed in; and,
selecting personalized content based on the category.

9. A computer implemented method comprising:
sending check code and a uniform resource locators (URL) from a server to a computer, the check code, when executed on the computer:
listing a reference to the URL so that an attribute of the listed reference to the URL varies depending on whether the URL is in a list indicating URLs visited by the computer, and
forwarding to the server, based on the attribute of the listed reference to the URL, an indication as to whether the URL is in the list indicating URLs visited by the computer; and,
selecting personalized content to be sent to the computer based on the indication.

10. A computer implemented method as in claim 9 wherein selecting personalized content to be sent to the computer based on the indication received from the check code comprises:
using the indication to aid placing the user of the computer in a category; and
selecting the personalized content based on the category.

11. A computer implemented method as in claim 9 wherein the URL is one of a plurality of URLs sent by the server to the computer along with the check code.

12. A computer implemented method as in claim 9 additionally comprising:
selecting the URL based on search results for a key word or key phrase.

13. A computer implemented method as in claim 9 additionally comprising:
selecting the URL based on search results returned from a search engine from a search on a key word or key phrase.

14. A computer implemented method as in claim 9 wherein the personalized content comprises advertising content.

15. A computer implemented method as in claim 9 wherein selecting personalized content to be sent to the computer based on the indication received from the check code comprises:
using the indication along with indications about other URLs visited by the computer to aid placing the user of the computer in a category; and
selecting the personalized content based on the category.

16. A computer implemented method as in claim 9 additionally comprising:
sending the selected personalized content to the computer from a second server that is not the server that sent the check code to the computer.

17. A server comprising:
a module that selects uniform resource locators (URLs) to be sent to a computer; and,
a block that prepares and sends web content, check code and a URL to a computer, the check code, when executed on the computer, listing a reference to the URL so that an attribute of the listed reference to the URL varies depending on whether the URL is in a list indicating URLs visited by the computer, and forwarding to the server, based on the attribute of the listed reference to the URL, an indication as to whether the URL is in the list indicating URLs visited by the computer; and,
a block that uses the indication to create tracking information about the computer, the tracking information being used to select content to be sent to the computer.

18. A server as in claim 17 wherein the URL is one of a plurality of URLs sent by the server to the computer along with the check code.

19. A server as in claim 17 wherein the module selects the URL based on search results for a key word or key phrase.

20. A server as in claim 17 wherein the tracking information as stored on the computer as a cookie.
